(19) United States
(12) Patent Application Publication
(10) Pub. No.: US 2021/0082017 A1
(43) Pub. Date: Mar. 18, 2021

(54) SYSTEM FOR EVENT PLANNING AND BOOKING

(71) Applicant: Aisle Planner Inc., Cardiff By the Sea, CA (US)

(72) Inventors: Rob Farrow, Encinitas, CA (US); Christina Farrow, Encinitas, CA (US)

(73) Assignee: Aisle Planner Inc., Cardiff By the sea, CA (US)

(21) Appl. No.: 17/020,387

(22) Filed: Sep. 14, 2020

Related U.S. Application Data
(60) Provisional application No. 62/899,745, filed on Sep. 13, 2019.

(51) Int. Cl. G06Q 30/06; G06Q 10/02

(52) U.S. Cl. CPC G06Q 30/0619; G06Q 30/0641; G06Q 10/025

(57) ABSTRACT

The system described herein relates to a computing system architecture that represents a unique new three-sided marketplace model. The system is bifurcated into two specific audiences that are interconnected through the application but create and consume content in different ways. The audiences are defined as 1.) Professionals which is comprised of individuals, LLC, Corps that by definition are business that provide services (and or products) to customers (other business or individuals) that use our platform to market their companies, connect with customers, process payments, execute contracts, design, plan and execute events 2.) Consumers who use our platform to find inspiration, discover resources, connect with professional service provides, contract with them for their services, purchase products, pay for products and collaborate in the designing, planning and execution of their events.

This patent application claims priority to U.S. Provisional Patent Application No. 62/899,745 filed on Sep. 13, 2019, which is incorporated by reference herein, in its entirety.

### BACKGROUND OF THE SYSTEM

The subject matter described herein relates to a computing system architecture that represents a unique new three-sided marketplace model designed and created by Aisle Planner Inc. The combination of services, interoperability and workflow in the areas of publishing, marketing, purchasing process and project management tools is by definition proprietary in nature and worthy of protection.

Aisle Planner is defined as a platform which is bifurcated into two specific audiences that are interconnected through the application but create and consume content in different ways. The audiences are defined as 1.) Professionals which is comprised of individuals, LLC, Corps that by definition are business that provide services (and or products) to customers (other business or individuals) that use our platform to market their companies, connect with customers, process payments, execute contracts, design, plan and execute events 2.) Consumers who use our platform to find inspiration, discover resources, connect with professional service provides, contract with them for their services, purchase products, pay for products and collaborate in the designing, planning and execution of their events.

### SUMMARY

The new system provides a method and apparatus for planning an event and booking merchants who provide the details for such an event. By providing a database repository of images of events that are linked to specific retailers that provided services for events, users can easily contact the retailer who created the theme that they are interested in.

### BRIEF DESCRIPTION OF THE DRAWINGS

FIG. 1 is a diagram of the elements of the architecture of the invention.

FIG. 2 is a diagram of the central API server.

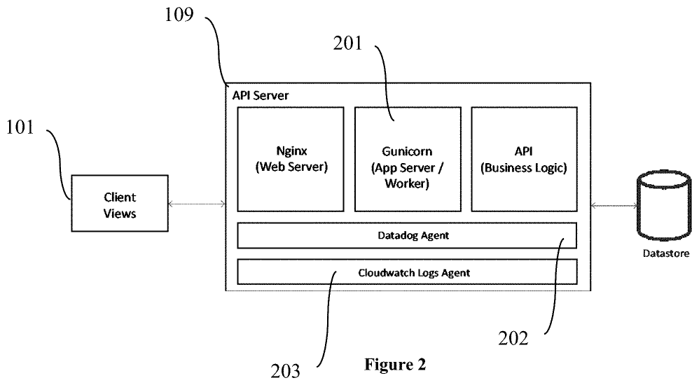

FIG. 3 is a diagram of the interactions between the worker and scheduler servers.

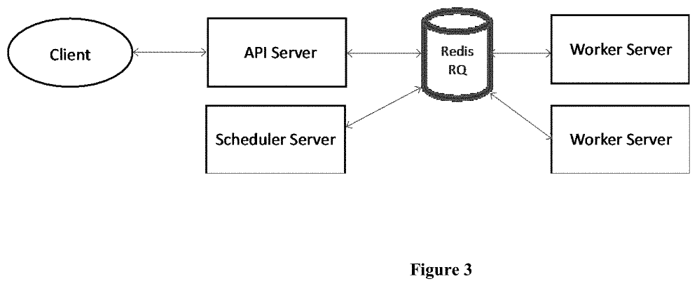

FIG. 4 is a depiction of a general purpose computing environment in one embodiment of the system.

### DETAILED DESCRIPTION OF THE SYSTEM

The system provides a system for connecting professionals and individuals by allowing professionals to market their business through a business listing or buying advertising; book their customers and managing the relationship with them; and plan, design, and execute their projects (weddings/events) while collaborating with individuals and other professionals throughout the process. The system is described herein.

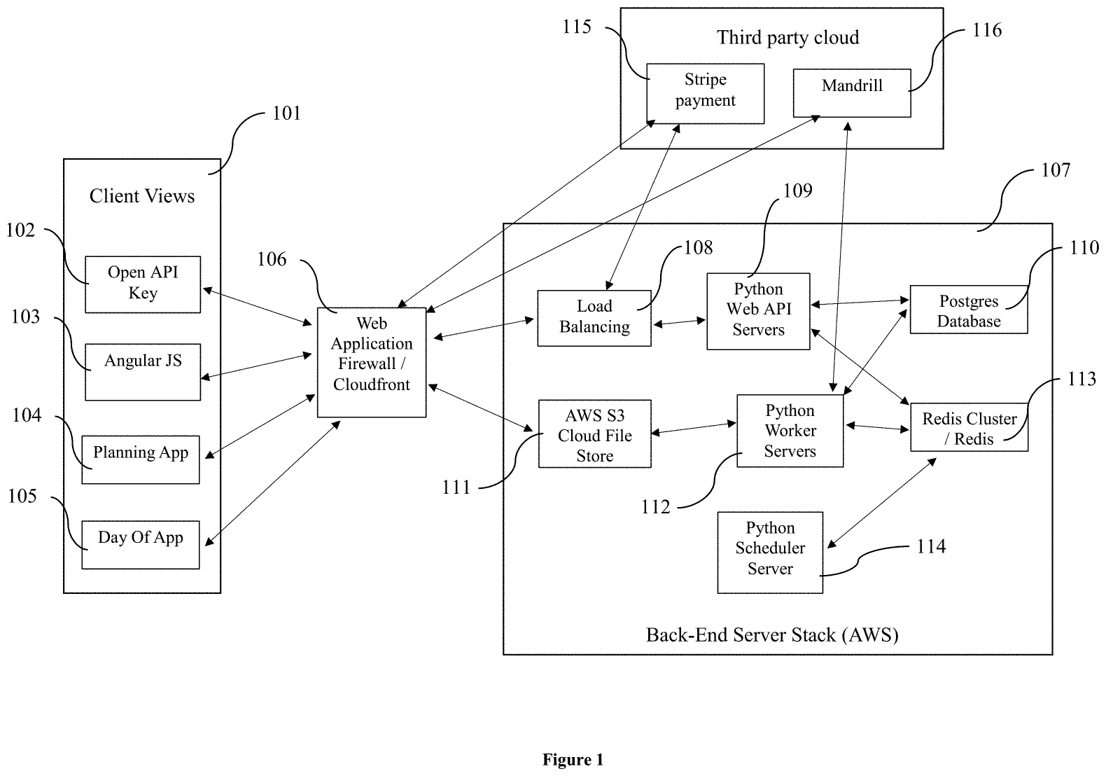

The architecture is made up of many elements which make up the system's core platform. Each element is built to scale to many users in a horizontal fashion within the cloud. This is expressed further via each platform element in FIG. 1.

The system has its main client view 101 available as a responsive web application 103. The application is written in AngularJS, HTML, and CSS which is created using a LESS compiler. When a user logs into the webapp 103 they download all the files to run the app immediately. From there, the webapp 103 provides a desktop app like experience where the user can navigate through the app and manage their customers, bookings, and events without a page refresh. All views in the webapp are rendered with AngularJS templates and API calls to the backend.

The app has an API library 102 that creates seamless integrations and connections with other applications so that users have the ability to create their own custom tool suites within the Aisle Planner environment. The system provides for two different types of connections defined as—Triggers and Actions. An example of a “Trigger” would the result of action that occurs within the Aisle Planner environment that would automatically trigger an action on an external app. An example of this would be when a payment is paid through the Aisle Planner system, and the client was also a client of QuickBooks, the payment would be seamlessly added to both Aisle Planner and QuickBooks. An example of an “Action” would be the result of an action that occurs outside of the Aisle Planer environment on another app allowing the user to map data from the external application into the Aisle Planner environment.

The system also utilizes two native iOS Apps—referred to as the “Planning App” 104 and the “Day Of App” 105. The “Planning App” 104 will allow individuals users to find their wedding inspiration, get advice on planning a wedding, and find and contact professionals. The “Day Of App” 105 will allow an individual users to send out notifications to others involved in a particular event on day of the event. This would include changes to the event timeline, and event layout, guest list, and seating, and contact and connect with professionals from the app without having to log into the web application. It will also provide Apple Watch integration for the wedding timeline notifications. Both of these iOS apps are being written in Swift and connect through the standard RESTFUL APIs to the system backend just as the webapp does.

In order to provide a scalable user experience with many different user and view layers it's important to have a central interface to all of the business logic and data that pertains to storing content. This is easily accomplished by providing a RESTful interface 106 behind the CloudFront Content Delivery Network (CDN) and the AWS Web Application Firewall (WAF).

Amazon Web Services (AWS) 107: https://aws.amazon.com/

AWS 107 is a cloud-based infrastructure as a service (IaaS) provider. AWS 107 makes it easy to deploy and configure server-based applications quickly providing an endless supply of server, database, networking, and storage resources.

For API requests, an Elastic Load Balancer (ELB) 108 sits in front of the web/API servers 109 and load balances traffic to the web/API servers 109 which are in an Autoscaling Group which allows the system to scale servers based upon incoming traffic. The system's backend servers run on Elastic Compute Cloud (EC2) and they are provisioned in a virtual datacenter called Virtual Private Cloud (VPC).

The system also uses many other AWS services to run its operations such as CloudFront, Web Application Firewall (WAF) 106, Route53, Simple Storage Service (S3) 111, Relational Database Service (RDS) 110, Elasticache Redis 113, Cloudwatch, Identity and Access Management (IAM) and many more services.

Python 2.7: https://www.python.org/

Python is a widely used high-level, general-purpose, interpreted, dynamic programming language. Its design philosophy emphasizes code readability, and its syntax allows programmers to express concepts in fewer lines of code than possible in languages such as C++ or Java. The language provides constructs intended to enable writing clear programs on both a small and large scale.

Python supports multiple programming paradigms, including object-oriented, imperative and functional programming or procedural styles. It features a dynamic type system and automatic memory management and has a large and comprehensive standard library. It was also the fastest growing programming language in 2018.

All three tiers of the system servers—web/API 109, workers 112, and the scheduler 114—are running Python 2.7.

Pyramid 1.x: https://docs.pylonsproject.org/projects/pyramid/en/latest/#

Pyramid is a small, fast, down-to-earth Python web framework. It is developed as part of the Pylons Project. It is licensed under a BSD-like license. Pyramid benchmarks as one of the fastest frameworks. It is also very configurable unlike many other more rigid frameworks allowing deep customization of the application architecture to customize it to the system's needs. It does this yet provides a robust framework to run a Python app within.

The system's web servers are running Pyramid 1.x along with many of its counterpart packages including pyramid-tm (transaction manager), pyramid-mako (Mako templating), and pyramid-redis-sessions (session management).

Gunicorn 201: http://gunicorn.org/

Gunicorn 201 or ‘Green Unicorn” is a Python WSGI HTTP Server for LINUX. Its pre-form worker model ported from Ruby's Unicorn project. The Gunicorn server 201 is broadly compatible with various web frameworks, simply implemented, light on server resources, and fairly speedy.

Datadog 202: https://www.datadoghq.com/

Datadog 202 is a monitoring service for cloud-scale applications, providing monitoring of servers, databases, tools, and services, through a SaaS-based data analytics platform. Datadog 202 helps developers and operations teams see their full infrastructure—cloud, servers, apps, services, metrics, and more—all in one place. This includes real-time interactive dashboards that can be customized to a team's specific needs, full-text search capabilities for metrics and events, sharing and discussion tools so teams can collaborate using the insights they surface, targeted alerts for critical issues, and API access to accommodate unique infrastructures.

Cloudwatch Logs 203: https://aws.amazon.com/cloudwatch/

The Amazon CloudWatch Logs service allows you to collect and store logs from your resources, applications, and services in near real-time. Currently over 30 AWS services publish logs to CloudWatch. The system utilizes Cloudwatch Logs for aggregating all server logs including app and Nginx logs. This is done by installing the Cloudwatch Logs agent 203 on each server and then streaming logs real-time back to Cloudwatch Logs.

Stripe 115: https://stripe.com/

Stripe 115 is a technology company whose software allows individuals and businesses to receive payments over the Internet. Stripe 115 provides the technical, fraud prevention, and banking infrastructure required to operate on-line payment systems. Marketplaces and platforms use Stripe Connect to accept money and pay out to third parties. Connect provides a complete set of building blocks to support virtually any business model, including on-demand businesses, e-commerce, crowdfunding, and travel and events.

The system uses Stripe 115 to manage recurring subscription billing. The system is also a Stripe Connect partner and has white labelled Stripe's Connect APIs to build invoicing and online payment solutions for its customers. Inside the system, a business can send invoices and collect online payments through the system platform.

As the demand on the system grows it requires a level of decoupling to run smoothly. Requests that take a lot of time to complete like image processing, generating PDFs, sending emails, etc. must be moved out of the line of the API request 109 and be dealt with asynchronously offline by a “worker” tier of servers 112. This “worker” tier allows the API to remain performant and allows a quick response to the user while log running processes happen offline.

Jobs get queued for the worker servers via two mechanisms—they can be generated from an API request, or they may be created by the scheduler server 114. The scheduler checks for batches of emails, notifications, or reminders that need to be sent and creates jobs in RQ 113 for the workers 112. The scheduler 114 also contains the crontab and runs all scheduled cron scripts.

Amazon Simple Storage Service (S3) 111: https://aws.amazon.com/

Amazon S3 111 is used to store images, file uploads, and other media. The worker servers get and put items into S3 during processing.

Redis Queue (RQ) 113: http://python-rq.org/

RQ (Redis Queue) 113 is a simple Python library for queueing jobs and processing them in the background with workers. It is backed by Redis and it is designed to have a low barrier to entry. It can be integrated in your web stack easily.

Mandrill 116: https://mandrill.com/

Mandrill 116 is a transactional email API owned by Mailchimp. It's reliable, powerful, and ideal for sending data-driven emails. The system uses Mandrill 116 for sending app driven email communications to its users.

Redis 113: http://redis.io/

Utilizing Redis 113 for a cache storage gives the ability for real time caching with minimal impact on the persistent database server. Redis is used for session management, caching, and queueing.

Postgres 110: https://www.postgresql.org/

Postgres 110 is an object-relational database management system (ORDBMS) with an emphasis on extensibility and standards-compliance. As a database server 110, its primary function is to store data securely, and to allow for retrieval at the request of other software applications. It can handle workloads ranging from small single-machine applications to large Internet-facing applications with many concurrent users. The system runs their production Postgres Database on Amazon RDS in a highly available cluster.

The system utilizes Amazon's S3 service 111 to store image assets, static assets and other media. To assist with the most efficient level of delivery the system has implemented AWS Cloudfront 106—providing a content delivery network hosting caching static assets closer to the user for faster delivery. The system also proxies all remote API calls through Cloudfront 106 to provide dynamic content acceleration—this is basically a persistent TCP connection between Cloudfront 106 and the backend servers 107 which is kept open, so no handshake is required before completing an API request.

Amazon Simple Storage Service (S3) 111: https://aws.amazon.com/

Amazon Simple Storage Service (Amazon S3) 111, provides developers and IT teams with secure, durable, highly-scalable cloud storage. Amazon S3 is easy to use object storage, with a simple web service interface to store and retrieve any amount of data from anywhere on the web.

Amazon Cloudfront: https://aws.amazon.com/cloudfront/

Amazon CloudFront 106 is a global content delivery network (CDN) service that accelerates delivery of websites, APIs, image assets, audio/video content or other web assets. CloudFront 106 can be used to deliver an entire website, including dynamic, static, streaming, and interactive content using a global network of edge locations. Requests for your content are automatically routed to the nearest edge location, so content is delivered with the best possible performance. Amazon CloudFront 106 is optimized to work with other Amazon Web Services, like AWS S3.

The system uses AWS to host all of its global infrastructure. The majority of the server stack runs in us-east-1 (Northern Virginia) but the server stack footprint is extended through Cloudfront 106 which provides POPs all over the world close to our customers. This allows quick handshaking with a local Cloudfront POP 106 for requests to our APIs 109 and then Cloudfront 106 proxies requests back to our origin in Northern Virginia.

The server stack resides in a Virtual Private Cloud (VPC)—similar to a virtual datacenter. The only difference is that this virtual datacenter concept allows our server stack to span and load balance over multiple datacenters that have built in redundancies such as sitting on different power grids, flood plains, etc. Access to servers is limited to IP addresses of our offices and residences only, so no brute force SSH attacks can be attempted due to a restrictive firewall to the companies IPs only.

Same is true for access to the databases. The databases live inside the virtual datacenter and are firewalled so only the server stack and our office IPs can connect to them.

All employees with access to the servers and the database are managed through AWS Identity and Access Management (IAM) and must have 2 Factor Authentication turned on in order to have that access. The access is kept to a small list of individuals who maintain the operations for the system.

The system uses Datadog 202 to manage and monitor our environment and uses alarming around specific metrics to be notified when a significant event is taking place. Currently, the web/API servers 109 perform autoscaling on their own, so they are self-managed. The worker and scheduler tiers of the application are managed via alarms in the case of process failures but also do use autoscaling to maintain server fleet sizes based upon expected traffic.

Rollbar is integrated into the application and is used as our error reporting and capture tool. It allows us to see what is occurring with users in production, and when a ticket comes in, we can use Rollbar to look up errors reported by the user and see the exact condition hit by the user. From there, if we determine we have a defect, that defect is logged in Pivotal Tracker and we determine whether it is an immediate patch candidate if it is critical and impairs usage of the app for a user, or we bundle it with a future release cycle.

Embodiment of Computer Execution Environment (Hardware)

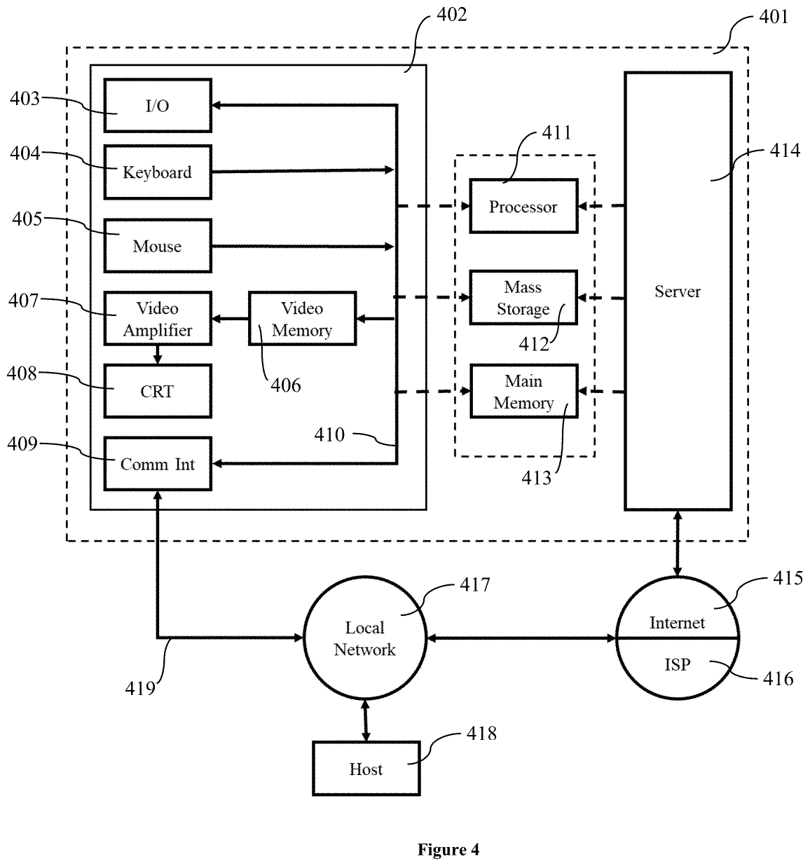

An embodiment of the system can be implemented as computer software in the form of computer readable program code executed in a general purpose computing environment such as environment 402 illustrated in FIG. 4, or in the form of bytecodes running on a processor (or devices enabled to process bytecodes) existing in a distributed environment (e.g., one or more processors on a network). A keyboard 404 and mouse 405 are coupled to a system bus 410. The keyboard and mouse are for introducing owner input to the computer system and communicating that owner input to central processing unit (CPU 411). Other suitable input devices may be used in addition to, or in place of, the mouse 405 and keyboard 410. I/O (input/output) unit 403 coupled to bi-directional system bus 410 represents such I/O elements as a printer, A/V (audio/video) I/O, etc.

Computer 402 may be a laptop, desktop, tablet, smart-phone, or other processing device and may include a communication interface 409 coupled to bus 410. Communication interface 409 provides a two-way data communication coupling via a network link 419 to a local network 417. For example, if communication interface 409 is an integrated services digital network (ISDN) card or a modem, communication interface 409 provides a data communication connection to the corresponding type of telephone line, which comprises part of network link 419. If communication interface 409 is a local area network (LAN) card, communication interface 409 provides a data communication connection via network link 419 to a compatible LAN. Wireless links are also possible. In any such implementation, communication interface 409 sends and receives electrical, electromagnetic or optical signals which carry digital data streams representing various types of information.

Network link 419 typically provides data communication through one or more networks to other data devices. For example, network link 419 may provide a connection through local network 417 to local server computer 418 or to data equipment operated by ISP 416. ISP 416 in turn provides data communication services through the world wide packet data communication network now commonly referred to as the “Internet” 415. Local network 417 and Internet 415 both use electrical, electromagnetic or optical signals which carry digital data streams. The signals through the various networks and the signals on network link 419 and through communication interface 409, which carry the digital data to and from computer 402, are exemplary forms of carrier waves transporting the information.

Processor 411 may reside wholly on client computer 402 or wholly on server 414 or processor 411 may have its computational power distributed between computer 402 and server 414. Server 414 symbolically is represented in FIG. 4 as one unit, but server 414 can also be distributed between multiple “tiers”. In one embodiment, server 414 comprises a middle and back tier where application logic executes in the middle tier and persistent data is obtained in the back tier. In the case where processor 411 resides wholly on server 414, the results of the computations performed by processor 411 are transmitted to computer 402 via Internet 415, Internet Service Provider (ISP) 416, local network 417 and communication interface 419. In this way, computer 402 is able to display the results of the computation to an owner in the form of output.

Computer 402 includes a video memory 406, main memory 413 and mass storage 412, all coupled to bi-directional system bus 410 along with keyboard 404, mouse 405 and processor 411.

As with processor 411, in various computing environments, main memory 413 and mass storage 412, can reside wholly on server 414 or computer 402, or they may be distributed between the two. Examples of systems where processor 411, main memory 413, and mass storage 412 are distributed between computer 402 and server 414 include thin-client computing architectures and other personal digital assistants, Internet ready cellular phones and other Internet computing devices, and in platform independent computing environments,

The mass storage 412 may include both fixed and removable media, such as magnetic, optical or magnetic optical storage systems or any other available mass storage technology. The mass storage may be implemented as a RAID array or any other suitable storage means. Bus 410 may contain, for example, thirty-two address lines for addressing video memory 406 or main memory 413. The system bus 410 also includes, for example, a 32-bit data bus for transferring data between and among the components, such as processor 411, main memory 413, video memory 406 and mass storage 412. Alternatively, multiplex data/address lines may be used instead of separate data and address lines.

In one embodiment of the system, the processor 411 is a microprocessor such as manufactured by Intel, AMD, Sun, etc. However, any other suitable microprocessor or microcomputer may be utilized, including a cloud computing solution. Main memory 413 is comprised of dynamic random access memory (DRAM). Video memory 406 is a dual-ported video random access memory. One port of the video memory 406 is coupled to video amplifier 407. The video amplifier 407 is used to drive the cathode ray tube (CRT) raster monitor 408. Video amplifier 407 is well known in the art and may be implemented by any suitable apparatus. This circuitry converts pixel data stored in video memory 406 to a raster signal suitable for use by monitor 408. Monitor 408 is a type of monitor suitable for displaying graphic images.

Computer 402 can send messages and receive data, including program code, through the network(s), network link 419, and communication interface 409. In the Internet example, remote server computer 414 might transmit a requested code for an application program through Internet 415, ISP 416, local network 417 and communication interface 409. The received code maybe executed by processor 411 as it is received, and/or stored in mass storage 412, or other non-volatile storage for later execution. The storage may be local or cloud storage. In this manner, computer 402 may obtain application code in the form of a carrier wave. Alternatively, remote server computer 414 may execute applications using processor 411, and utilize mass storage 412, and/or video memory 406. The results of the execution at server 414 are then transmitted through Internet 415, ISP 416, local network 417 and communication interface 409. In this example, computer 402 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the system may be implemented in any type of computer system or programming or processing environment.

Thus, a method and apparatus for creating customizable social platforms has been described.

What is claimed is:

1. A computer implemented method of connecting professionals and individuals comprising:
at least one primary platform aimed towards professionals;
wherein said primary platform allows professionals to market their goods and services for events;
at least one secondary platform aimed towards consumers;
wherein said secondary platform allows consumers to view and purchase the goods and services offered by said professionals using said primary platform;
wherein said secondary platform allows consumers to plan events;
automatically generating a notification on the primary platform when a lead, project or payment is submitted by a consumer on the secondary platform; and
automatically generating a notification on the secondary platform when a professional submits a timeline, layout, guest list, seating or other event information on the primary platform.
